(19) United States
(12) Patent Application Publication
(10) Pub. No.: US 2013/0048823 A1
(43) Pub. Date: Feb. 28, 2013

(54) Support for electronic equipment

(71) Applicant: Timothy Carter Rich, Wakefield, RI (US)

(72) Inventor: Timothy Carter Rich, Wakefield, RI (US)

(21) Appl. No.: 13/573,095

(22) Filed: Aug. 21, 2012

Related U.S. Application Data
(60) Provisional application No. 61/575,360, filed on Aug. 22, 2011.

(51) Int. Cl. F16M 13/00

(52) U.S. Cl. 248/346.3

(57) ABSTRACT

A device for supporting portable electronic equipment (including but not limited to laptop computers) that will allow the flow of cooling air and limit the amount of heat produced by the equipment that is transmitted to the surface on which the laptop computer and device are placed. The design of the device allows it to be folded or rolled up for easy packing and transportation.

### CROSS-REFERENCE TO RELATED APPLICATION

This application claims priority from Provisional Application Ser. No. 61/575,360, filed Aug. 22, 2011.

### FIELD OF THE INVENTION

The invention relates to a device for supporting portable electronic equipment (including but not limited to laptop computers) that will allow the flow of cooling air and limit the amount of heat produced by the equipment that is transmitted to the surface on which the laptop computer and device are placed. The design of the device allows it to be folded or rolled up for easy packing and transportation.

### BACKGROUND OF THE INVENTION

Portable electronic equipment (including laptop computers) generates heat that needs to be dissipated for optimal performance. The design of the equipment often incorporates internal fans and vents in the bottom and/or sides of the equipment to circulate air and cool CPUs and other critical components. Especially when the equipment is supported on something other than a flat, hard surface, e.g., when supported on a user's lap, these cooling vents and fans may be wholly or partially covered, interfering with the cooling function, and transmitting heat to the user's lap.

### SUMMARY OF THE INVENTION

The present invention provides a simple, low cost support for electronic equipment that spaces the equipment away from an underlying support, such as a user's lap, allowing the flow of cooling air as intended by the manufacturer, and thus presumptively improving the equipment's reliability. The support device of the invention comprises a series of parallel tubes secured to one another so as to allow flow of cooling air, while providing a secure support surface. Even where the equipment does not employ internal fan(s) and vent(s), the device aids the cooling process by allowing air to move around the electronic equipment.

### BRIEF DESCRIPTION OF THE DRAWINGS

FIG. 1 shows a perspective view of a first embodiment of the device with an element of electronic equipment, exemplified by a laptop computer, resting on the top surface of the device.

FIG. 2 shows a front view of the device with a laptop computer resting on the device.

FIG. 3 shows a side view of the device as used to support a laptop computer, illustrating the manner in which the device provides separation from the surface upon which the device is placed, and allowing relatively free flow of air to the electronic equipment.

FIG. 4 shows a view of the device comparable to that of FIG. 3 and specifically illustrates employment of the flexible connection between the tubes of the device to fold a tube over an underlying tube, further elevating the laptop computer and providing increased air circulation beneath the laptop computer.

FIG. 5, comprising FIGS. 5(a)-(d), shows a side view of one embodiment of the device, in which it is comprised of square-section hollow tubes joined by a sheet of flexible material adhesively bonded to corresponding surfaces of the tubes, allowing the device to be folded.

FIG. 6 shows a perspective view of the device.

FIG. 7 shows a top view of the device in an embodiment wherein a sheet of flexible material having had a graphic image printed thereon is adhesively bonded to the top surface of the tubes. The same effect can also be achieved by printing the graphic image directly on the tubes.

FIG. 8, comprising FIGS. 8(a) and (b), shows respectively perspective and side views of the device in an embodiment using round hollow tubes connected to one another by strings extending through holes in the tubes, securing them together.

FIG. 9, comprising FIGS. 9(a)-(h), shows side views of various embodiments of the device of the invention, employing tubes of differing cross-sectional shapes connected by strings or by a sheet of flexible material adhesively bonded to the corresponding surfaces of the tubes.

FIG. 10, comprising FIGS. 10(a)-(e), shows perspective views of various embodiments of the device of the invention, employing square tubes and a piano style hinge system. The respective hinge barrels would typically be attached to the tubes and snapped together as shown.

FIG. 11 shows a perspective view of the device utilizing piano style hinges connecting the tubes.

FIG. 12, comprising FIGS. 12(a)-(f), shows side views of various embodiments of the device of the invention, employing round tubes connected by different styles of flexible connections between each tube.

### DETAILED DESCRIPTION OF THE INVENTION

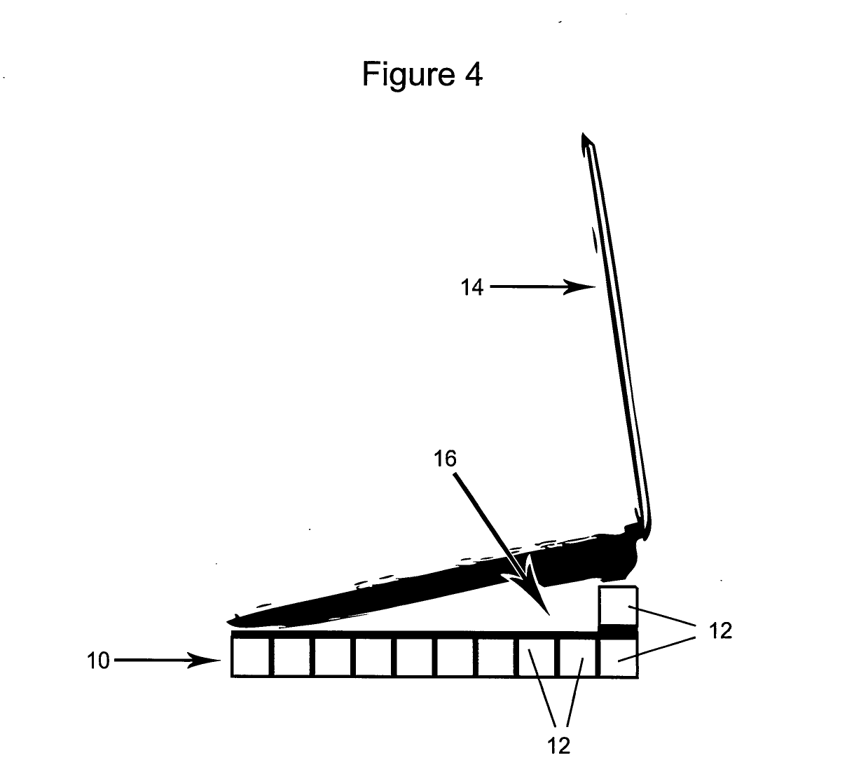

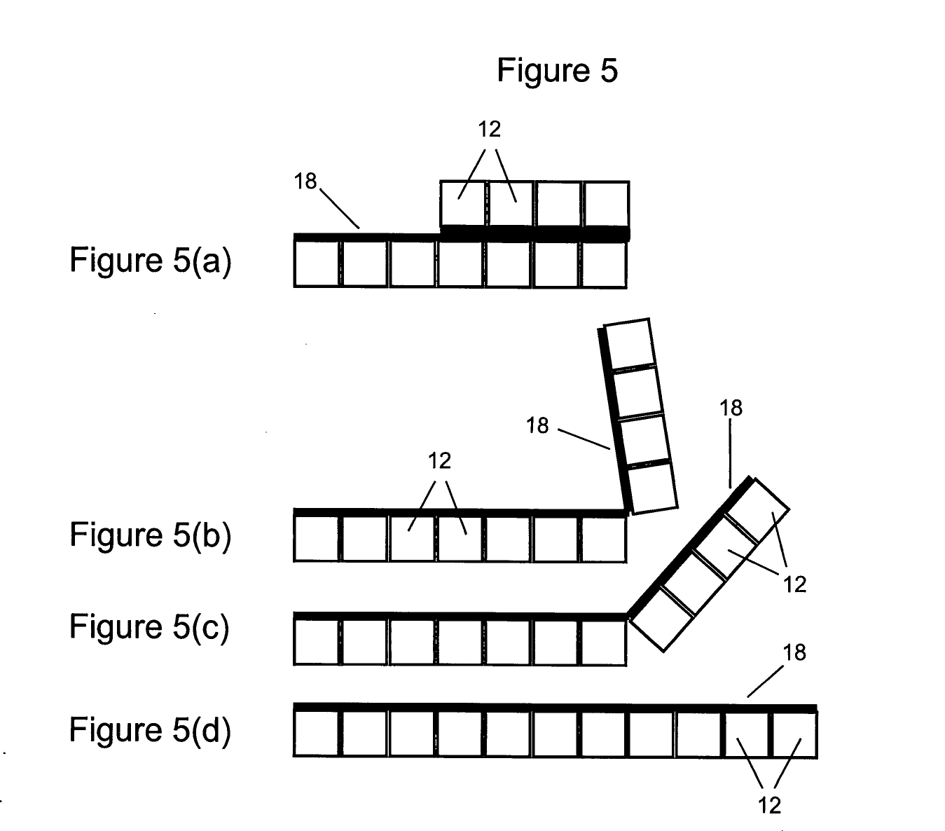

As noted above, the support device of the invention supports electronic equipment so as to space it away from an underlying surface and allow airflow both through and around electronic equipment placed on the device. For example, laptop computers are often placed on a person's lap where clothing, bedclothes and the like can block the vents and fans, limiting air circulation and trapping heat inside the equipment. The device provides a supporting surface that allows movement of air to help reduce the temperature of the equipment. As illustrated in the various Figures, the device is made up of parallel hollow tubes, spacing the equipment from the underlying support surface, preventing bedclothes and the like from blocking airflow to the vents and/or fans. The hollow nature of the tubes provides for airflow therethrough, insulating the equipment from the underlying surface and limiting heat flow therebetween. The design of the device also allows tubes to be folded on top of each other (see FIGS. 4 and 5), thus creating a larger air space between the bottom of the equipment and the device and therefore allowing additional air to flow through and around the equipment.

As noted, laptop computers and like electronic equipment are frequently used while supported on clothing, bedding materials, pillows, and the like. Supporting a laptop computer or the like on such non-uniform surfaces can commonly inhibit airflow to the vents and/or fan of the electronic equipment, and can also allow accumulated dust contained in the user's clothing, bedding materials, and the like to be drawn into its cooling system. The accumulation of this dust reduces the cooling capability of the equipment. Use of the device helps limit the amount of dust that will be drawn into the electronic equipment and also provides the other benefits disclosed in this application.

As illustrated in the various Figures, the hollow nature of the tubes making up the support device of the invention also helps to insulate the body heat generated by a person's lap from reaching the electronic equipment and otherwise adding body heat to the electronic equipment. The hollow tubes also allow air to flow within the tubes and provide another escape route for warm air generated by a person's body as well as heat generated by the electronic equipment.

A further benefit of the device is the reduction of the amount of heat generated by a laptop computer that is transferred to the body of the user. There are documented cases where prolonged exposure to the heat generated by a laptop has caused a skin condition known as “Toasted Skin Syndrome”. The use of this device helps promote the flow of cooling air and insulate the user's body from the heat generated by a laptop computer or other portable electronic device.

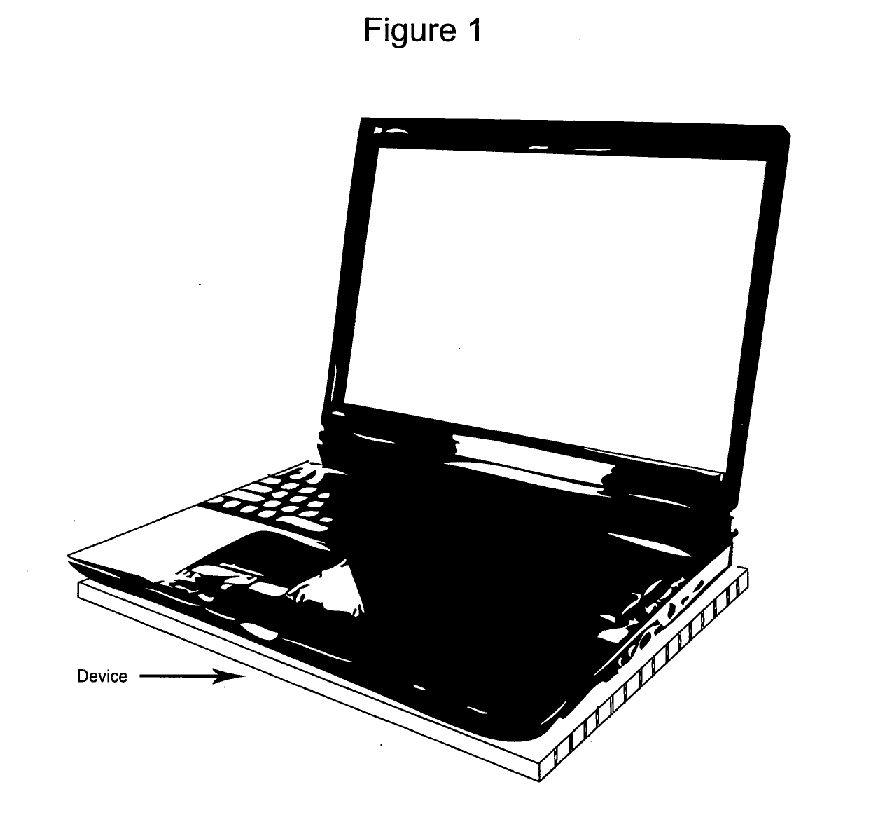

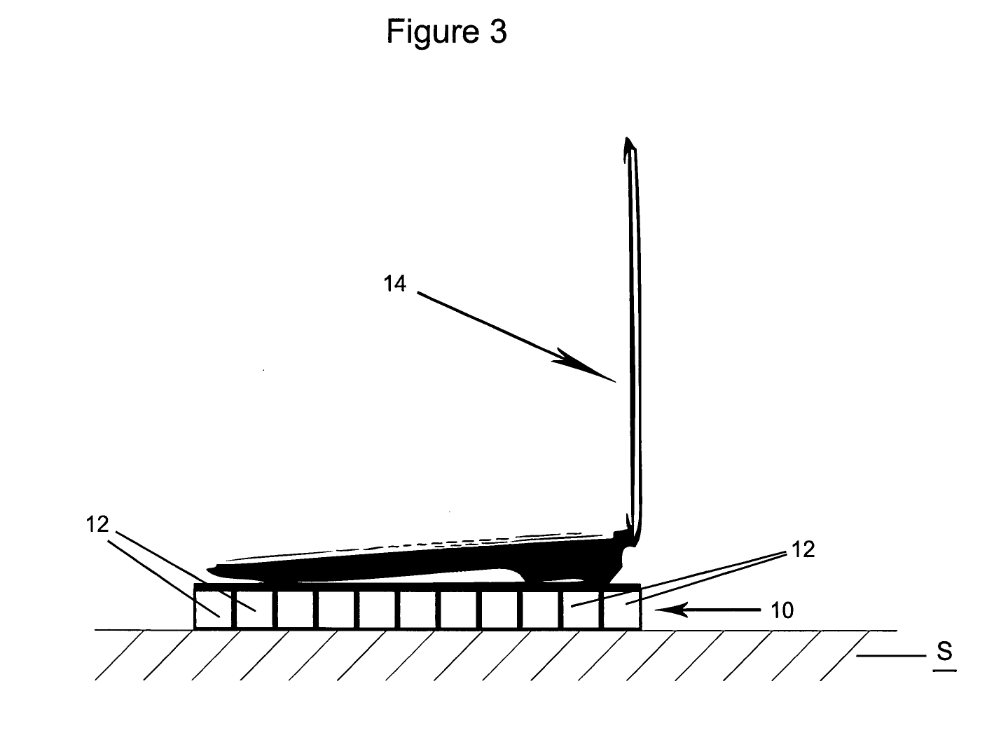

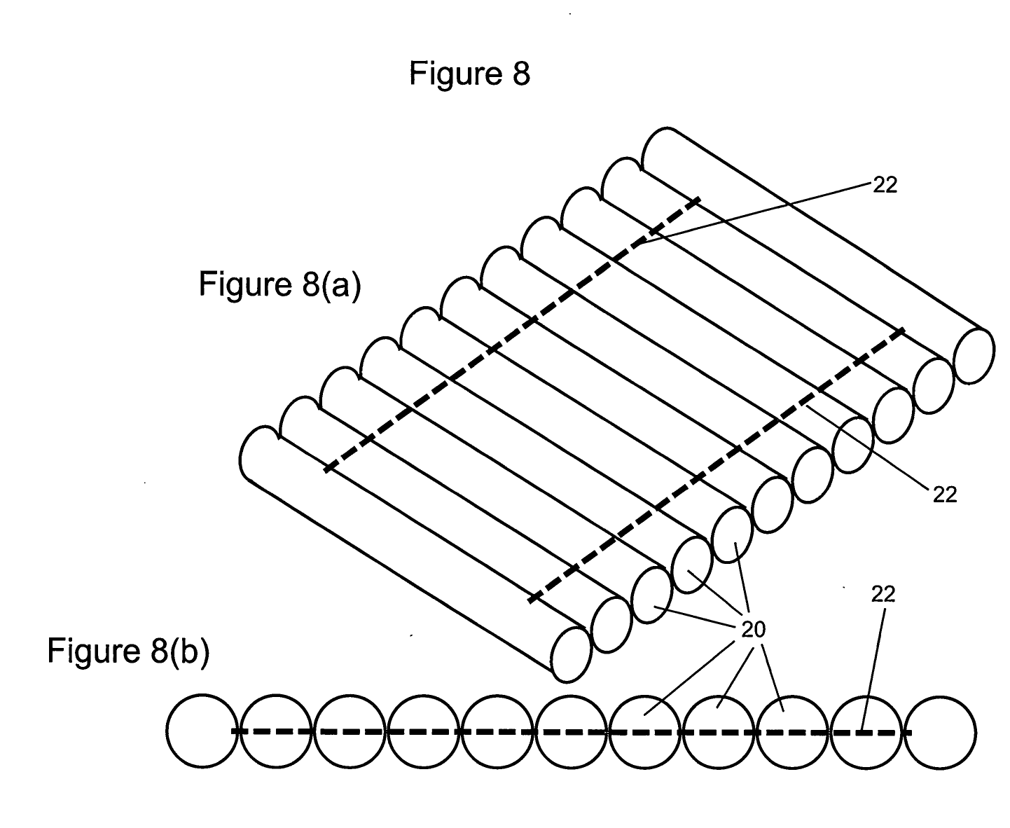

The device is passive, in that no internal or external power supply is needed. The device comprises a series of substantially identical hollow, open-ended tubes arranged parallel to one another, side by side, with their ends aligned so as to form a substantially rectangular planar member as shown in FIGS. 3, 4, 5, 6, 8, 9, 11, and 12. The tubes are preferably made of an inexpensive, lightweight material such as PETG plastic but various additional lightweight materials (such as aluminum or composite materials such as fiberglass, carbon fiber, etc.) are envisioned to work well. The cross-sectional shape of the tubes can be square as shown in FIGS. 3, 4, 5, 6, 9(c), 9(d), 10 and 11 or other shapes (see FIGS. 8, 9, and 12). When fully “open” and ready to use, as shown in FIGS. 1, 6, and 7, the size of the device is approximately 9″ wide and 15″ long, to match the dimensions of the typical laptop computer, and its thickness is essentially that of the outside dimension of the tubes, e.g., ½ inch. Other dimensions and tube thicknesses are envisioned depending on the electronic equipment to be used with this device.

The tubes are secured to one another by any suitable means that allows flexing and folding of the device as shown in FIGS. 4 and 5. For example, the tubes can be connected by a sheet of flexible material adhesively bonded to corresponding surfaces of the tubes, as shown in FIGS. 3, 4, 5, 6, 7, 9(a), 9(c), 9(e), 9(g) and 9(h). The flexible material can be paper, vinyl, or another film or fabric. The adhesive can be applied directly to the tubes or to the flexible material so long as the bond between the tubes and the flexible material is strong and durable.

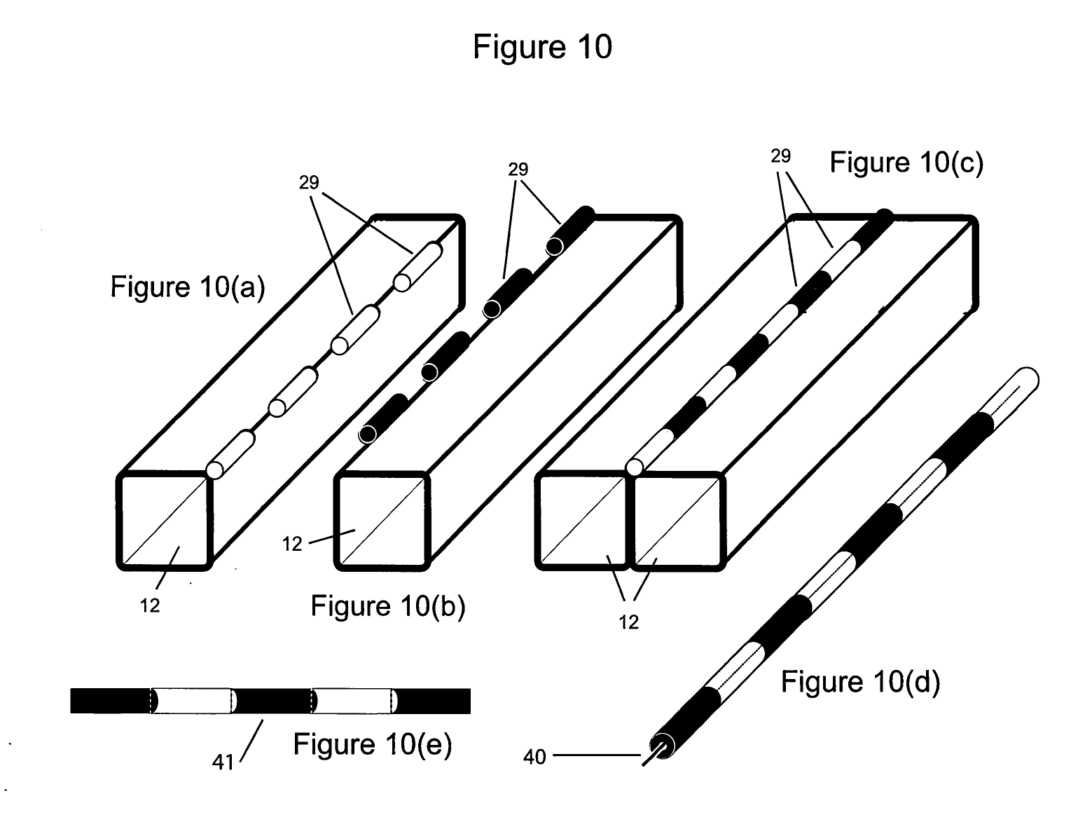

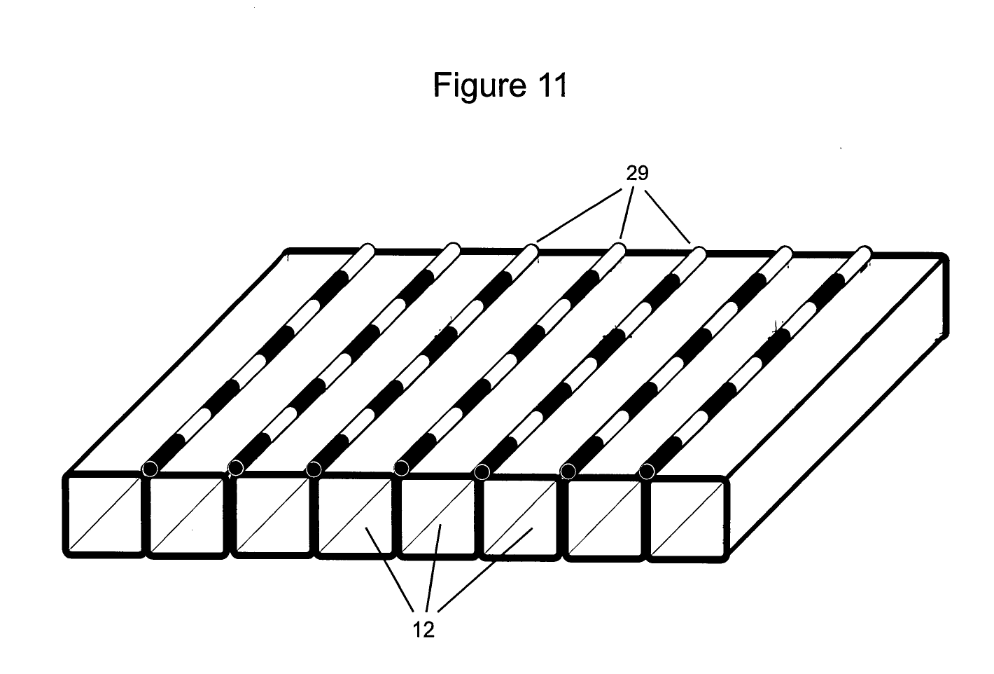

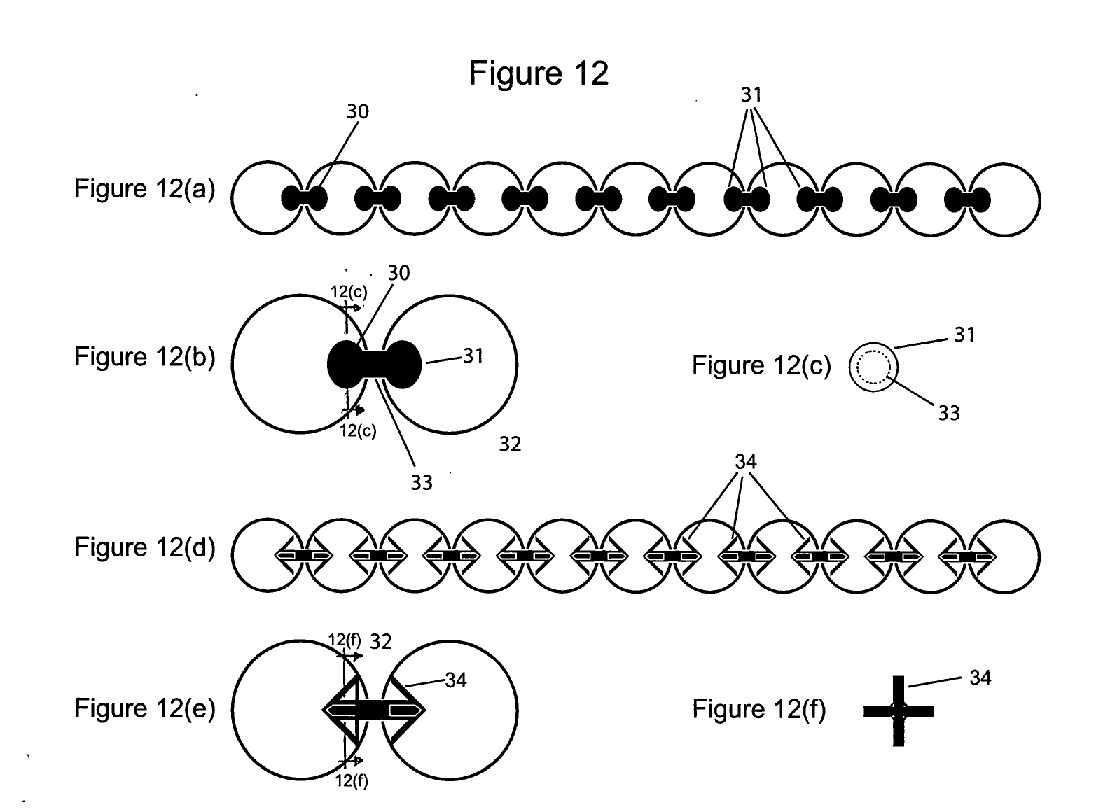

It is also envisioned that the tubes could be attached to each other with a flexible joint or joints between each tube. The tubes can be connected by flexible connectors inserted between the tubes, as shown in FIGS. 12(a)-(f). Another means of attaching the tubes and maintaining the required flexibility of the device is the use of a piano style hinge as shown in FIGS. 10 and 11.

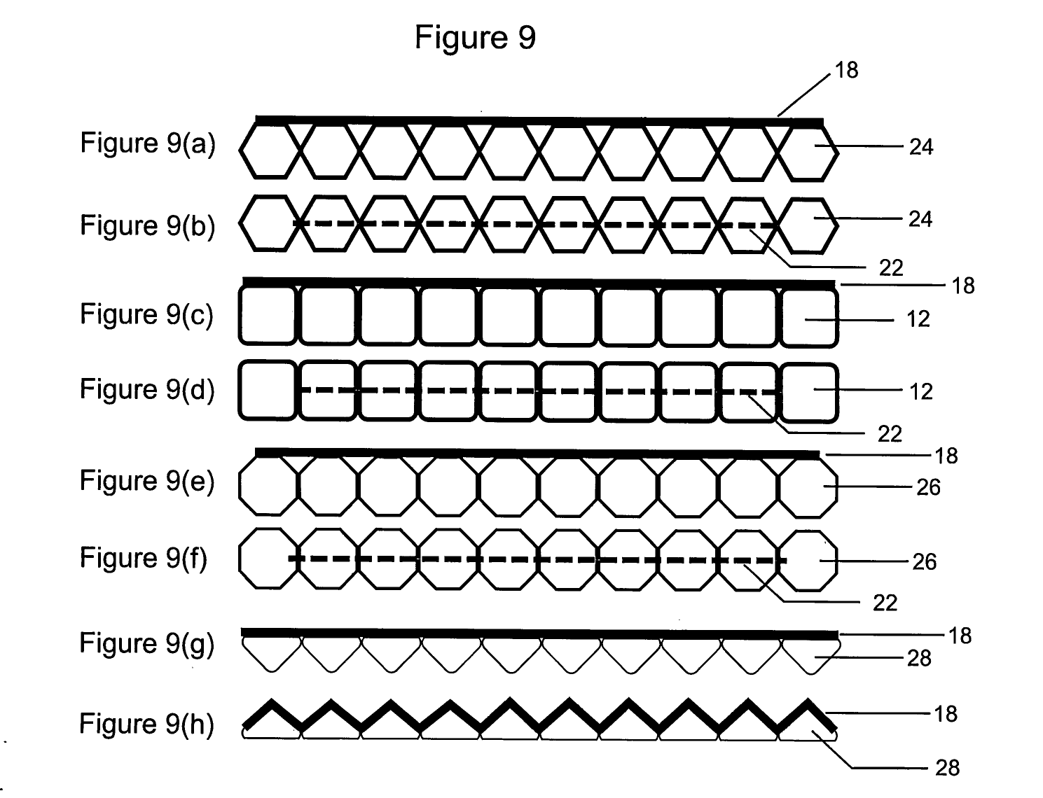

The tubes may alternatively be secured to one another by string(s) or elastic type cord(s) running through corresponding holes in the opposed sides of the tubes, as shown in FIGS. 8, 9(b), 9(d) and 9(f).

Alternative methods of providing flexible connection of the tubes are within the skill of the art.

It is also within the scope of the invention to employ more than one method of joining the tubes to one another; for example, the hinge pin system could be employed together with an adhesively-bonded sheet of material.

Referring now to the specific features of the device of the invention as shown in the various Figures:

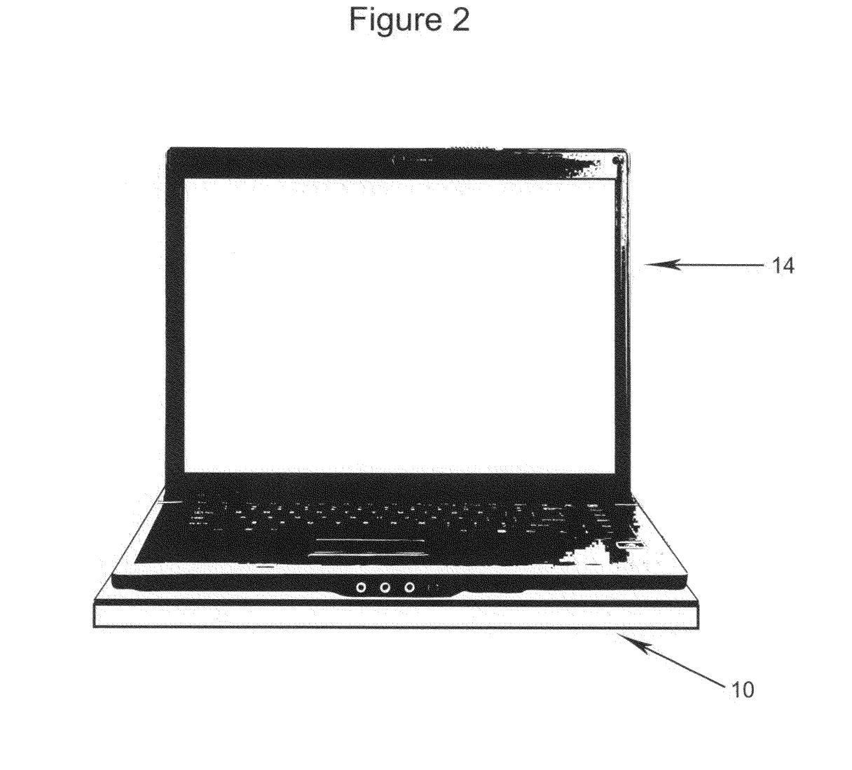

FIGS. 1-3 show the device 10, comprising a number of parallel hollow tubes 12 secured to one another, supporting a laptop computer 14, and spacing it from an underlying surface S (FIG. 3).

FIG. 4 shows how the device may be folded so that a rearmost tube 12 rests atop the adjoining tube, so that when the laptop is placed on the device an additional airspace 16 is created; the user may also prefer the computer to be inclined in this way. Folding over just a front tube (not shown) reverses the angle if this is preferable to the user, while folding over both a front and a rear tube (not shown) provides additional air space for cooling and raises the laptop further from the underlying surface.

FIG. 5 shows that the device can be folded at the intersection between any of the adjoining tubes, for convenience in use and storage. In this embodiment, the ability to fold the device between adjoining tubes 12 is provided by the flexibility of the sheet material 18 adhered to corresponding surfaces of the tubes; similar flexibility is provided by the string attachment method shown in FIGS. 8, 9(b), 9(d) and 9(f).

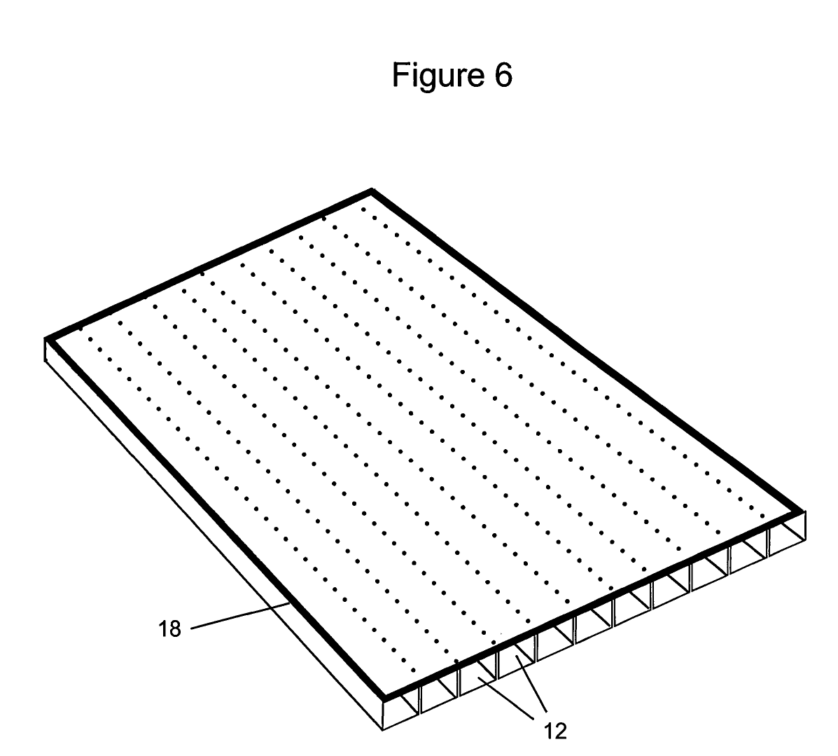

FIG. 6 shows a perspective view, illustrating how the flexible sheet material 18 connects the tubes 12 to one another. The dotted lines indicate the position of the adjoining tubes.

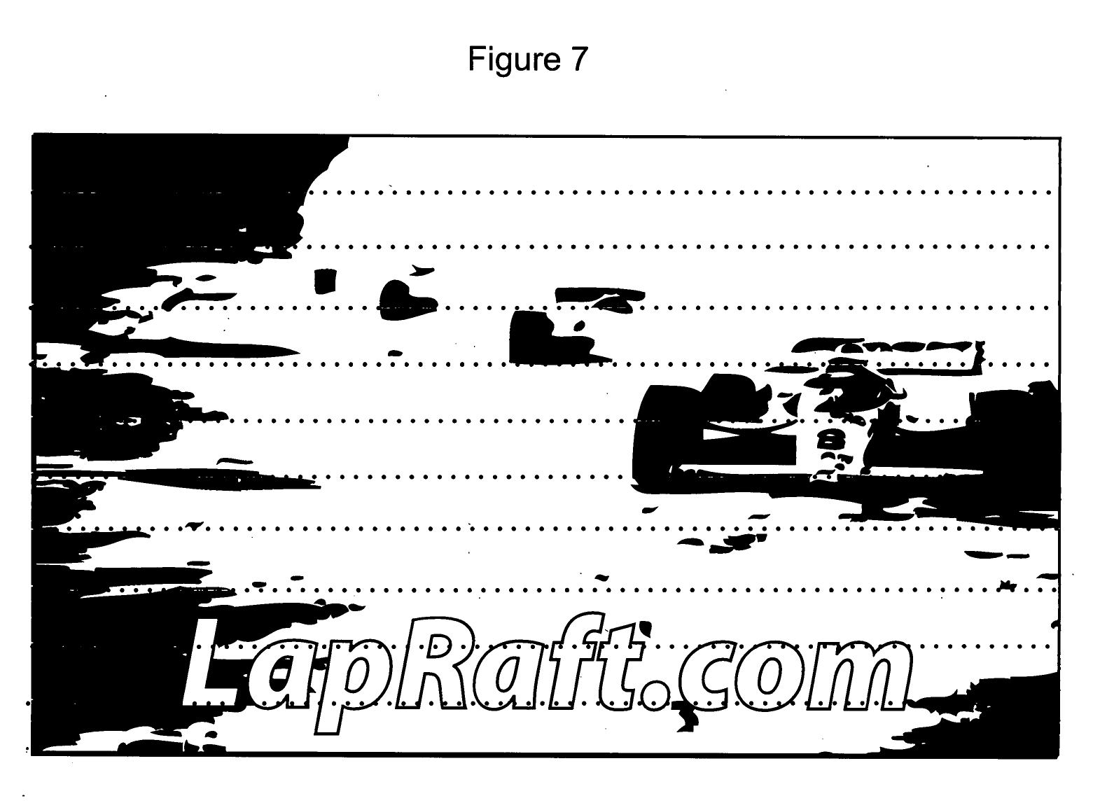

FIG. 7 shows how the flexible sheet material 18 may be printed with advertising or promotional images. The dotted lines again indicate the position of the adjoining tubes. As above, the image can be printed directly on the tubes if strings are used to secure the tubes to one another.

FIG. 8 shows that circular-section tubes 20 may be employed, and can be connected by strings 22 of, e.g., monofilament lines or elastic material, extending through corresponding holes (not shown) bored in the opposite sides of the tubes. The strings 22 can be secured to the tubes on the edges of the assembly by knotting or adhesives.

FIG. 9 shows that various additional cross-sectional shapes may be chosen for the tubes, and may be secured to one another by a flexible sheet material 18 or by strings 22. Thus, in FIG. 9 (a), hex-section tubes 24 are joined by sheet material 18; in FIG. 9(b), hex-section tubes 24 are joined by strings 22; in FIG. 9(c), square-section tubes 12 are joined by sheet material 18, and in FIG. 9(d) by strings 22; in FIG. 9(e), octagon-section tubes 26 are joined by sheet material 18, and in FIG. 9(f) by strings 22; and in FIGS. 9(g) and (h) two ways of joining triangular-section tubes 28 by sheet material 18 are illustrated.

FIG. 10 shows the use of a piano style hinge to make the flexible connection between tubes. Barrel sections 29 of the hinge are attached to the tubes 12. The barrel sections of the hinge would be molded into the tube sections or attached to the tubes in a separate process. The corresponding ends of the barrels could have a cooperating “bump and recess design” 41—see FIG. 10(e)—so that multiple tubes can be snapped together to assemble a complete device. Alternatively, hinge pins 40 could be passed through the barrel sections of the hinges to secure the tubes to one another. See FIG. 10(d).

FIG. 11 shows the use of a piano style hinge to connect the tubes 12. Barrel sections 29 on each tube snap together and allow the hollow tubes 12 to fold on the hinge(s) as described previously.

FIG. 12 shows two styles of flexible connectors 30 and 32 that could be used to attach the tubes to one another. The connectors 30 and 32 are made of somewhat deformable elastic material allowing for flexing between tubes. FIGS. 12(a)-(c) show a first embodiment in which the connector 30 comprises opposed ball ends 31 joined by a central member 33. Ball ends 31 can be forced through the corresponding holes in the tubes but will not be pulled out of the holes during normal use of the device. That is, in this embodiment the material of the tubes is deformed during insertion of the ball ends, providing a “snap-fit” assembly. FIGS. 12 (d)-(f) show a further embodiment wherein the ends comprise resilient fingers 34 that are forced together as they are inserted into the corresponding holes in adjacent tubes, and then spread open after passing through the holes in the tubes, preventing the connector from being pulled out of the tube. FIGS. 12(c) and 12(f) show enlarged cross-sectional end views of the flexible connectors.

Thus, as shown, in use the device of the invention provides a surface to support electronic equipment. This allows air to circulate around the equipment. If the equipment has cooling fans or vents airflow is not obstructed as it might be if the equipment were placed on a soft surface or the lap of a human operator of the equipment.

The hollow design of the tubes allows air movement within the tubes to help further dissipate heat produced by the electronic equipment. The air in the tubes also acts as an insulating barrier between the top and bottom surfaces of the tubes and in combination with air movement reduces the heat transmitted from the electronic equipment to the surface on which the device is placed, and vice versa.

The device is designed to be lightweight, portable and durable in order to withstand daily use in the work, home and mobile environments.

What is claimed is:

1. A support structure for electronic equipment, comprising:
a plurality of substantially identical elongated tubular members, disposed side by side parallel and closely juxtaposed to one another and with their ends aligned, and one or more connecting member(s) joining adjacent ones of said tubular members to one another so as to form a generally planar rectangular assembly, and wherein said connecting member(s) are such that limited motion of each tubular member with respect to its neighbor(s) is permitted, while said tubular members remain parallel to one another.

2. The support structure of claim 1, wherein said at least one connecting member(s) comprise at least two cords extending through corresponding bores in opposed walls of each of said tubular members and secured to the outermost tubes of said assembly.

3. The support structure of claim 1, wherein said at least one connecting member(s) comprises a sheet of flexible material adhered to aligned surfaces of said tubes.

4. The support structure of claim 3, wherein said tubular members are generally rectangular in cross-section and said sheet of flexible material is adhered to substantially coplanar flat surfaces of said tubular members.

5. The support structure of claim 1, wherein said at least one connecting member(s) comprises paired connectors, each comprising opposed end members of a first cross-sectional dimension joined by a central section of reduced cross-sectional dimension, and wherein said opposed end members are inserted into and through mating bores in the tubular members, said bores being less in diameter than the cross-sectional dimension of said opposed end members.

6. The support structure of claim 4 wherein the material of the tubular members is such as to permit distortion of the tubular members to permit insertion of the opposed end members.

7. The support structure of claim 4 wherein the opposed end members comprise elongated fingers that are distorted in order to permit insertion of the opposed end members into the bores in the tubular members.

8. The support structure of claim 5 wherein two of said paired connectors are employed to secure each of said tubular members to each adjoining tubular member.

9. The support structure of claim 1, wherein said at least one connecting member(s) comprises cooperating hinge members secured to adjoining ones of said tubular members.

10. The support structure of claim 9, wherein said cooperating hinge members comprise structure affixed to the tubular members, said structure defining apertures for receiving hinge pins assembling said tubular members to one another while permitting relative motion thereof.

11. The support structure of claim 9, wherein said cooperating hinge members comprise structure affixed to the tubular members, said structure defining cooperating protruding members on one of each pair of adjoining tubular members adapted to be received by recesses on the other of each pair of adjoining tubular members.
